(19) United States
(12) Patent Application Publication
(10) Pub. No.: US 2009/0100744 A1
(43) Pub. Date: Apr. 23, 2009

(54) Bait box

(75) Inventor: Stefan Endepols, Burscheid (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer CropScience AG, Monheim (DE)

(21) Appl. No.: 11/579,622

(22) PCT Filed: Apr. 22, 2005
(86) PCT No.: PCT/EP2005/04340

§ 371 Date: Aug. 29, 2008

(30) Foreign Application Priority Data
May 5, 2004 (DE) 10 2004 022 103.0

(51) Int. Cl. A01M 25/00; A01M 1/20

(52) U.S. Cl. 43/131; 43/124

(57) ABSTRACT

The present invention relates to a) a bait box which is adapted to the use of bait-containing blisters; b) a system for the use of bait-containing blisters in pest control, consisting of a bait box and bait-containing blisters; c) the use of the bait box or of the system; and d) methods for controlling pests.

The present invention relates to a bait box which is adapted to the use of bait-containing blisters; a system for the use of bait-containing blisters in pest control, consisting of a bait box and bait-containing blisters; to the use of the bait box or of the system; methods for controlling pests.

The prior art describes a variety of bait boxes for controlling pests. U.S. Pat. No. 3,750,326 discloses a bait box made of cardboard which has lateral accesses and check ports arranged at the top. U.S. Pat. No. 4,349,982 discloses a bait box made of plastic which has lateral accesses and a port arranged at the top which is suitable for refilling the box with flowable bait. DE-A 195 01 892 discloses an open-top bait box without lateral accesses which is covered by an optionally transparent film arranged at a distance. WO 02/102147 and U.S. Pat. No. 5,136,803 describe bait boxes in various designs whose lid can be opened for refilling the box with bait and for checking purposes and which are additionally equipped with devices for holding block-shaped feed baits in place. DE-A 36 11 122 describes bait-containing blisters with pharmaceutical active substance for the treatment of animals.

While the known bait boxes are suitable for the use of solid baits, they have a series of disadvantages: in order to fill bait boxes with solid baits, such as wax blocks or pastes, they must be opened. To prevent these compact baits from falling out or from being taken away by the rodents, they are placed into dimensionally accurate compartments or grids (DE-A 39 05 489), threaded onto metal skewers (Protecta® Tamper Resistant Bait Box for rats) or held in place with wire (DE-U 299 01 578). Only flowable baits can be introduced without opening the bait box (U.S. Pat. No. 4,349,982).

A further disadvantage of the known bait boxes is that, as a result of their construction, they are not, or not very well, suited for use with bait-containing blisters.

A further disadvantage of the known bait boxes is that simple and/or rapid refilling, in particular with bait-containing blisters, is not possible.

A further disadvantage of the known bait boxes is that rapid and uncomplicated checking of the bait boxes is not possible.

Pests are frequently controlled using feed baits. These baits can be displayed openly when it can be ruled out that they will be taken up by non-target animals or influenced by abiotic factors such as climatic factors or cleaning procedures. To rule out largely these influences, bait boxes (also referred to as bait stations) are frequently used.

Bait boxes for controlling harmful insects consist, as a rule, of plastic and will already have been filled with bait by the manufacturer. The insects gain access to the bait by one or more accesses; if possible, they should be attracted by the bait. As a rule, these bait boxes are not refilled but disposed of after the control has been effected.

Bait boxes for harmful rodents, specifically for mice, are offered by some manufacturers as filled bait boxes. They contain one or more compact feed baits. Again, these bait boxes are not refilled, as a rule, but are disposed of after the control has been effected. As an alternative, bait boxes are used which are repeatedly refilled by the user during the control procedure. These baits can be used in a plurality of control activities, or else remain in place for the continuous prophylaxis against infestation, where they are refilled at intervals of up to 3 months. Frequently, these stations are sealed in order to make access by those without authorization difficult (WO 02/102147) or they are designed in such a way that only the target animals reach the feed bait (DE-A 39 05 489).

In comparison with the use of ready-filled bait boxes, which are disposed of after use, the opening of the reusable bait boxes is an additional pass whose complexity depends on the closing mechanism of the box. Compact baits must be manipulated by hand. Trained professional users wear protective gloves in order to prevent contamination of the skin. Work time is required for filling bait boxes with compact baits, and protective gloves must be worn.

While compact baits in the unused state are easy to fix in place, there is a risk that parts of these baits fall out of the bait station or are taken away once the rodents have started eating them. Partly eaten compact baits risk contamination of the environment.

Bait boxes which can be filled externally without opening the bait box are known for flowable bait. Here, there is an increased risk that bait particles fall out of the stations or are taken away, which must be ruled out in particular in animal keeping and in the production of food- and feedstuffs. Flowable baits which are introduced externally into a bait box therefore pose a grave safety risk.

This is why the baits used in animal keeping and in the production of food- and feedstuffs are predominantly compact baits. While they can be fixed in place readily while in the unconsumed state, there is, again, the risk that parts of these baits fall out of the bait box or are dragged away when they have been partly consumed by the rodents. Again, partly consumed baits pose the risk of contaminating the environment.

Baits should be placed into the bait box in such amounts as are indicated in the manufacturer's instructions. Portions of flowable baits must therefore be measured before introducing them. In doing so, it is easy to spill bait. As a rule, non-professional users are not equipped for dividing baits into portions. Incorrect dosage can adversely affect successful control. Metering flowable baits can be a source of mistakes and harbors the risk of exposing user and environment to the bait.

Baits can be provided in divided packs whose content corresponds to the recommended amount for one bait station. To allow these portions to be stored, they must be sealed hermetically and not allow aromas to escape. For use, they must be opened in order to be attractive for the target animals, for example mice, and, if appropriate, attract the latter. Depending on the packaging material used, this procedure can entail an effort, or the packaging may be destroyed to a greater degree than desired. This entails the risk that the user's skin comes into contact with the bait or that the bait is spilt. Divided packagings must be opened for use and harbor the risk of exposing user and environment to the bait.

It is an object of the present invention to do away with the abovementioned disadvantages by providing a novel bait box and a bait system.

The object is achieved by the features of claim 1 and of the further claims.

In the context of the present invention, the following terms will be used, inter alia:

Pests are harmful rodents, harmful insects or slugs and snails. Harmful rodents are, in particular, rats, mice and voles. Harmful insects are, in particular, crawling insects such as cockroaches, ants and termites.

Blister packs are already used widely in the food and pharmacological sectors for packaging purposes and are generally known to the skilled worker. Characteristic of such packagings are unilaterally open shaped articles for accommodating the material to be packaged, in the present case the feed bait, which are made of a relatively rigid material (“blister shell”) and a cover of this shaped article which is made of a relatively nonrigid material (“blister film”).

Feed baits are compositions which are eaten by the pest in question and which contain at least one feedstuff and at least one poison which is active against the pest in question, at an effective concentration. The poison used is a rodenticide or insecticide, depending on the target animal. A large number of different formulations for feed baits are known to the skilled worker and are commercially available. Feed baits can be formulated as compact shaped articles (“bait-block”), as a free-flowing or flowable bait or as a gel (“bait gel”).

Bait gels are feed baits with a pasty or gel-like consistency. The viscosity of the usable bait gels can be varied within wide limits and is generally at 5000-100 000 mPas, preferably 8000-60 000 mPas, especially preferably 10 000-50 000 mPas. The viscosity is measured using a rotary viscometer (from HAAKE) at a shear rate of D=10 [1/sec] or determined using a cone-and-plate system (4°). The readings vary as a result of the heterogeneity of the bait gels. The viscosity can be adjusted by varying the type and proportion by weight of the components, in particular the thickener and the bait material. Bait gels are known for example from WO 03/094612. The bait gel compositions disclosed therein are herewith expressly referred to. Fat-based pasty formulations (“pasty bait gels”) are generally known to the skilled worker.

Bait blocks are feed baits in solid form. Bait blocks are known in different forms; their size depends on the pest to be controlled and varies between 1 g and 300 g. Such bait blocks are known to the skilled worker for example from DE-A 198 37 064.

Bait blisters are feed baits in a blister pack. In principle, it is possible to use any feed bait. Feed baits which adhere to the blister are preferably used. Suitable examples are bait gels and bait blocks. Bait blocks are preferably heated and, while in the liquid state, poured into the blister, where they solidify at room temperature. The advantage of bait blisters is that they are fresh and soft upon use, even when they contain water. For the control of mice, one portion contains 1 g to 50 g of bait, preferably 3 g to 30 g and especially preferably 5 g to 15 g. For the control of rats, one portion contains 10 g to 300 g. Suitable packs have a content of from 20 g to 200 g, especially suitably 70 g-130 g.

A bait box is a box for controlling pests, comprising at least one lateral access for the pest and space for a feed bait. Preferably, a bait box has two lateral accesses. The size of the lateral accesses is adapted to suit the pest to be controlled.

In addition to the accesses for the pest (b) the bait box according to the invention additionally has at least one device for opening the bait-containing blister (d). “Opening” the bait-containing blister is understood to mean damaging of the blister film, which results in the pests being capable of becoming aware of the feed bait and which is sufficient for the pest to open the blister film to such an extent that they reach the feed bait. Opening can be effected for example by making holes, tears or cuts into the blister film, or by completely removing the blister film.

In addition to the accesses for the pest (b), the bait box according to the invention preferably has in addition at least one port for introducing the bait-containing blister (c) and a device for opening the bait-containing blister (d). The port for introducing the bait-containing blister can be located at the top, laterally or in the bottom of the bait box. A lateral port is preferred.

A lateral port (b) which is preferred is one whose size is matched to the cross-section of the bait-containing blister (e) in such a way that the latter can be pushed, in a horizontal direction, in a dimensionally accurate fashion through the port into the bait box. “Dimensionally accurate” is understood as meaning a gap dimension which is small enough to prevent the pest to be controlled from entering and to make gnawing at the bait difficult. Gap dimensions of 0.1-5 mm are suitable, gap dimensions of 0.5-2 mm are preferred.

In a preferred embodiment, the lateral port can be closed by an additional device, for example a flap or a slide bar.

In a preferred embodiment, the bait-containing blister is fixed in place within the bait box by means of suitable devices. This can be accomplished for example by two transverse walls or a plurality of check pins.

A preferred device for opening the bait-containing blister (d) is a vertical strip made of a rigid material (“blade”) which is attached to the inside of the lid of the bait box. This blade is connected resiliently to the lid and is located above the point where the introduced bait pack is fixed in place. In the relaxed state, the distance between the bottom of the box and the lower edge of the blade is smaller than the height of the bait pack. Upon sliding in, the hard edge of the bait-containing blister pushes the blade upwards. When the bait pack has reached the envisaged position within the box, the edge of the packaging in the direction of pushing has reached a position behind the lower edge of the blade. The resiliency of the blade is adjusted in such a way that it will now spring home, during which process it will pierce the film of the bait pack. Preferably, the blade is curved in such a way that it causes as large a tear as possible.

In an alternative embodiment, a wick, pin or hook is provided for opening a bait-containing blister (d).

In an alternative embodiment, a cutting wheel is provided for opening a bait-containing blister (d).

In an alternative embodiment, a plurality of devices are provided for opening a bait-containing blister (d).

In an alternative embodiment, the devices for opening a bait-containing blister (d) may contain an adjusting means. Preferably, a hook or handle (g) which is suitable for bringing the device (d) into an upper and/or lower position is preferably used. Preferably, the element (g) is used for bringing the device (d) into an upper position for removing the bait-containing blister (e).

The relative movement resulting upon pushing the bait-containing blister (d) into the bait box (a) results in an efficient opening of the bait-containing blister (d).

In an alternative embodiment, the bait box is not provided with a resiliently positioned blade, but with a blade which is firmly connected with the lid. The lid can be opened as is the case with known bait boxes. Again, the sealed package with the bait is placed into the box, which must previously be opened. When the box is shut, the blade opens the lid of the package. In this embodiment, the lateral port can be dispensed with.

The bait box may be provide with a transparent portion which is arranged in such a way that the bait-containing blister is visible. In this way, the amount of available feed bait, and the necessity of refilling, can be estimated without the box having to be opened. The transparent portion is preferably arranged on the upper side of the box.

Bait boxes can be made of plastic, metallic materials or composite materials. Plastic is preferably used. Particularly suitable plastics are those which can be processed by injection molding. The sizes of the bait box is adapted to match the pest to be controlled. In general, the size of the bait box is such that at least one pest can move within the bait box and space for the feed bait is additionally available. The determination of the correct size is known to the skilled worker and can also be gathered from the above prior art or commercially available bait boxes.

In a further embodiment, the bait box is designed in such a way that it cannot be opened. This furthermore increases the safety of the bait box for the user.

The various alternative and preferred embodiments can be combined with one another.

The present invention furthermore describes a system for controlling pests, consisting of a bait box as described above and a bait-containing blister as described above which is adapted thereto. The adaptation is accomplished by matching the bait-containing blister and the fill pod of the bait box. The adaptation can furthermore be accomplished by adapting the size of the bait box, the fill quantity of the bait-containing blister and the choice of the feed bait to the pest to be controlled and the bait boxes to be filled. The adaptation can furthermore be accomplished by matching the material of the blister film and the material of the blade to one another so that efficient opening of the blister is brought about. Such adaptations can be carried out by the skilled worker himself with the aid of simple calculations and routine experiments.

The system according to the invention has the following advantages:

it makes possible the use of a fresh and, if appropriate, moist bait which is particularly attractive;

opening of the bait packaging is dispensed with;

no risk of contaminating skin and environment with bait as a result of spillage;

the bait comes in optimal portions as per the manufacturer's technical data;

the bait cannot fall out of the box or be taken away.

The present invention furthermore relates to a method of controlling pests using bait boxes and bait-containing blisters, characterized in that, in a first step, one or more bait boxes as claimed in claim 1 to 4 are placed in suitable locations; in a second step, unopened bait-containing blister is introduced into the bait box (during which process the bait-containing blister is opened); in a third step, the pests are controlled by means of the filled bait box, and, in a fourth step, any spent bait-containing blisters are replaced by fresh bait-containing blisters until the control procedure has ended. To remove the used bait-containing blister, it is preferred to unlock, or bring into the upper position, the device (d) by means of an element (e).

The present invention furthermore relates to the use of the bait boxes according to the invention in a method as described in EP-A 1 389 039; this publication, and the method described therein, are herewith expressly referred to.

### USE EXAMPLE

### Bait System for Controlling House Mice

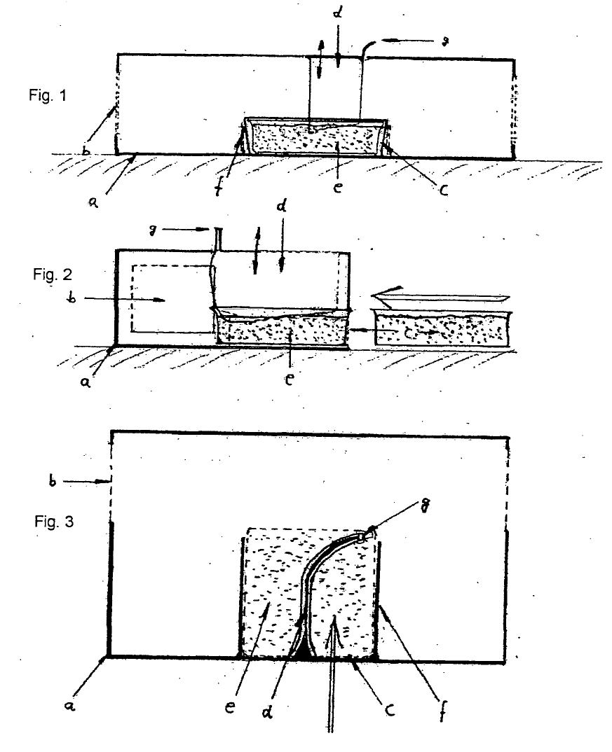

The bait box (a) has the dimensions 12 cm×7 cm×3 cm (L×W×H) and has 2 accesses (b) for mice. The blade (d) is fixed resiliently at the lid of the box and is provided with a hook (g) by means of which it can be raised in order to empty the box. It is curved laterally in order to cause as large a tear as possible. The packaged bait (e) is pushed into the bait box via the port (c), where it is fixed in place by means of two transverse walls (f). The package (4 cm×4 cm×1.1 cm) contains approx. 13 cm³ bait gel. Upon pushing in the package (FIG. 2), the blade is pushed upwards. Once the bait container has reached its final position, the blade is released downwards, slides downwardly along the lateral wall of the blister and tears an opening into the film of the bait package. Such a tear in the packaging is sufficient to attract mice since they can now smell the bait. To better reach the bait, they will tear or push away the film further.

The diagram which follows shows a possible embodiment of the bait box according to the invention, the system according to the invention and also illustrates the use of the bait box.

a. Bait box

b. Access for pest

c. Insertion port

d. Opening device (blade)

e. Bait-containing blister

f. Retaining wall for bait-containing blister

g. Unlocking element (hook/handle)

1. A bait box for controlling pests, comprising at least one access which is adapted to match the pest to be controlled, and at least one device for opening a bait container.

2. The bait box as claimed in claim 1, comprising at least one port for introducing the bait container (bait-containing blister).

3. The bait box as claimed in claim 1 or 2, wherein the port for introducing the bait container (bait-containing blister) is arranged laterally.

4. The bait box as claimed in claim 1 or 2, whose upper portion is transparent.

5. The bait box of claim 1 or 2, where the device for opening the bait-containing blister is designed as a sprung, curved blade.

6. A system for controlling pests consisting of a) a bait box as claimed in claims 1 or 2, and b) a bait-containing blister, characterized in that the port of the bait box and the shape of the bait-containing blister are adapted in such a way that the bait-containing blister can be pushed in a

7. (canceled)

8. A method of controlling pests, characterized in that, in a first step, at least one bait box of claim 1 or 2 is placed in a suitable location; in a second step, unopened bait containing blister is introduced into the bait box (during which process the bait-containing blister is opened); in a third step, the pests are controlled by means of the filled bait box, and, in a fourth step, any spent bait-containing blisters are replaced by fresh bait-containing blisters until the control procedure has ended.

9. The bait box of claim 3, wherein the upper portion is transparent.

10. The bait box of claim 3, wherein the device for opening the bait-containing blister is designed as a sprung, curved blade.

11. A system for controlling pests consisting of a) a bait box as claimed in claim 3, and b) a bait-containing blister, characterized in that the port of the bait box and the shape of the bait-containing blister are adapted in such a way that the bait-containing blister can be pushed in a dimensionally accurate fashion through the port into the bait box.
